(19) United States
(12) Patent Application Publication
(10) Pub. No.: US 2026/0326607 A1
(43) Pub. Date: Oct. 22, 2026

(54) ELECTRIC VEHICLE CHARGING

(71) Applicant: Diebold Nixdorf, Incorporated, North Canton, OH (US)

(72) Inventors: Douglas Kurt Hartung, San Antonio, TX (US); W. Edward Crooks, Coply, OH (US)

(21) Appl. No.: 19/491,133

(22) PCT Filed: Jun. 7, 2024
(86) PCT No.: PCT/US2024/033165

§ 371 Date: Dec. 8, 2025

Related U.S. Application Data
(60) Provisional application No. 63/471,870, filed on Jun. 8, 2023.

(51) Int. Cl. B60L 53/66; B60L 53/12; B60L 53/30; B60L 53/36; B60L 53/38; B60L 53/62; B60L 53/68; G06Q 20/32; G06Q 20/40; G06Q 50/06

(52) U.S. Cl. CPC B60L 53/665; B60L 53/12; B60L 53/305; B60L 53/36; B60L 53/38; B60L 53/62; B60L 53/68; G06Q 20/3223; G06Q 20/3226; G06Q 20/40145; G06Q 50/06; B60L 2240/72; B60L 2240/80; B60L 2250/16

(57) ABSTRACT

Described herein are methods for providing electric vehicle charging services. In an example embodiment, there is disclosed herein a method of operating an electric vehicle charging station that also provides additional services. A user is authenticated via a user interface with the electric vehicle charging station and upon authenticating the user electric vehicle charging is provided. In addition, upon additional authentication and/or payment, the user can perform one of a group consisting of a banking transaction, a retail transactions, a purchase of streaming services, a purchase of television services, a purchase of phone services, and a purchase of videoconferencing services. In particular embodiments, the electric vehicle charging station can schedule charging times for an autonomous electric vehicle and provide data to the autonomous electric vehicle to enable the autonomous electric vehicle to arrive at the scheduled time period.

### CROSS REFERENCE TO RELATED APPLICATIONS

This application claims the benefit under 35 U.S.C. § 119 of U.S. Provisional Application No. 63/471,870 filed Jun. 8, 2023,

### TECHNICAL FIELD

The present disclosure relates generally to providing charging services to electric vehicles.

### BACKGROUND

Due to concerns about climate change, electric vehicles are rising in popularity. Some states have even passed laws outlawing the sale of gasoline powered cars after a predefined date. Electric vehicle owners and operators have the option to purchase a flat fee charging program or a pay as you go charging program.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein a method for selecting an electric vehicle charging station and scheduling a time period for charging the electric vehicle that comprises obtaining data representative of an electric vehicle charging system plug type for an electric vehicle, obtaining data representative of a current battery charge level for the electric vehicle, obtaining data representative of a route for the electric vehicle, and obtaining data representative of a traffic condition for the route. The electric vehicle charging station is selected from a plurality of electric vehicle charging stations based on the electric vehicle charging system plug type, the current battery charge level for the electric vehicle, the route for the electric vehicle, and the data representative of a traffic condition for the route. A time period for charging the electric vehicle is scheduled.

In accordance with an example embodiment, there is disclosed herein a method for selecting an electric vehicle charging station (EVCS) for charging an electric vehicle. The method comprises obtaining data representative of an electric vehicle charging system plug type for an electric vehicle, obtaining data representative of a current battery charge level for the electric vehicle, obtaining data representative of a route for the electric vehicle, and obtaining data representative of a traffic condition for the route. An available electric vehicle charging station is selected from a plurality of electric vehicle charging stations based on the electric vehicle charging system plug type, the current battery charge level for the electric vehicle, the route for the electric vehicle, and the data representative of a traffic condition for the route. A time period for charging the electric vehicle at the selected electric vehicle charging station is scheduled. Other embodiments include an apparatus and computer readable medium capable of implementing the aforementioned method.

In accordance with an example embodiment, there is disclosed herein a method of operating an electric vehicle charging station. A user is authenticated via a user interface with the electric vehicle charging station and upon authenticating the user electric vehicle charging is provided. In addition, upon additional authentication and/or payment, the method further comprises the user performing one of a group consisting of a banking transactions, a retail transactions, a purchase of streaming services, a purchase of television services, purchase phone services, and a purchase of videoconferencing services. Other embodiments include an apparatus and computer readable medium capable of implementing the aforementioned method.

In accordance with an example embodiment, there is disclosed herein, a method that employs an inductive charging system for charging an autonomous, electric vehicle. A controller coupled with an inductive charging device receives charging data from an autonomous electric vehicle. The controller schedules a time period for charging the autonomous electric The controller sends a signal to the autonomous, electric vehicle causing the electric vehicle to arrive at the inductive charger for the scheduled time period.

### BRIEF DESCRIPTION OF THE DRAWINGS

The accompanying drawings incorporated herein and forming a part of the specification illustrate the example embodiments.

FIG. 1 is a block diagram illustrating a system for electric vehicle charging upon which an example embodiment can be implemented.

FIG. 2 is a block diagram illustrating an example of a mobile device upon which an example embodiment can be implemented.

FIG. 3 is a block diagram illustrating an example of a server suitable for the system of FIG. 1.

FIG. 4 is a block diagram illustrating an example of an electric vehicle coupled with a charging station upon which an example embodiment can be implemented.

FIG. 5 is a block diagram illustrating an example of an electric vehicle coupled with a charging station and a mobile, wireless device communicating with the electric vehicle charging station.

FIG. 6 is a block diagram illustrating an example of an electric vehicle charging station upon which an example embodiment can be implemented.

FIG. 7 is a block diagram illustrating an example of an electric vehicle wireless charging system that employs an in-ground wireless charging pad.

FIG. 8 is a block diagram illustrating an example of charging an electric vehicle charging system for autonomous electric vehicles that employs a wired connection.

FIG. 9 is a block diagram illustrating an example of a method for selecting an electric vehicle charging station.

FIG. 10 is a block diagram illustrating an example of a method of operating an electric vehicle charging station.

FIG. 11 is a block diagram illustrating an example of a method of charging an autonomous electric vehicle with an electric vehicle wireless charging system.

FIG. 12 is a block diagram illustrating an example of a method of charging an autonomous electric vehicle with an electric vehicle wired charging system.

FIG. 13 is a block diagram illustrating an example of a computer system upon which an example embodiment can be implemented.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Described in examples embodiments herein is a method for selecting an electric vehicle charging station (EVCS) from a plurality of electric vehicle charging stations. As will be described herein, the selection is based on one or a combination of inputs which may vary in different embodiments.

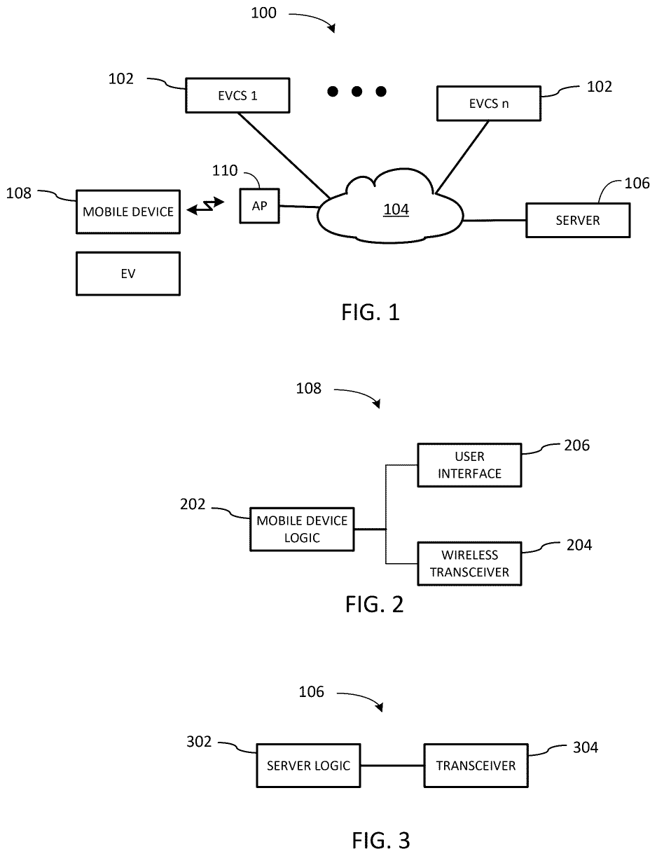

FIG. 1 is a block diagram illustrating a system 100 for electric vehicle charging upon which an example embodiment can be implemented. The system comprises a plurality of electric vehicle charging stations (EVCS 1-EVCS n, where n is an integer greater than 1) 102 coupled with a network 104. A server 106 is coupled with network 104 and coordinates the activities plurality of electric vehicle charging stations 102. A mobile device 106 associated with a customer communicates with the server 106 over network 104 via an access point (AP) 110.

The electric vehicle charging stations 102 are located at different locations. However, some locations may have more than one electric vehicle charging stations. Different electric vehicle charging stations 102 can have different capabilities, such as for example, different plug types, different (or more than one) charging levels, some can be associated with loyalty programs, and as will be described herein, infra, some electric vehicle charging stations can offer other services.

The network 104 provides communication between devices, such as for example, between server 106 and electric vehicle charging stations 102 and AP 110. The network 104 can employ one or more protocols for providing communication.

In an example embodiment, the network 104 comprises wired links. In another example embodiment, the network 104 comprises wireless links. In yet another example embodiment, the network 104 comprises both wired and wireless links.

The server 106 communicates with the electric vehicle charging stations 102 and as will be described in more detail herein coordinates activities of the electric vehicle charging stations 102. The server 106 is also configured to communicate with mobile devices 108 associated with customer and/or customer electric vehicles to select an EVCS 102. In an example embodiment, the server 106 schedules time periods for electric vehicles to charge at selected electric vehicle charging stations 102.

The mobile device 108 can be any suitable mobile computing device that can communicate on network 104 that is associated with an electric vehicle (EV). The mobile device 108 can employ a wired or wireless communications for communicating on network 104. For example, the mobile device 108 can be a vehicle's computer system, As another example, the mobile device can be a cell phone, such as for example, a smartphone.

The access point (AP) 110 couples the mobile device 108 with the network 104 for communications. In an example embodiment, the AP 110 provides cellular communications with mobile device 108. In another example embodiment, the AP 110 provides wireless network access, such as for example WIFI, with the mobile device 108. In yet other example embodiments, the AP 110 can be capable of providing cellular or wireless networking services to mobile device 108 to communicate with network 104.

In an example embodiment, the server 106 obtains data from the plurality of electric vehicle charging stations 102 that includes, but is not limited to, capabilities such as types of plugs, level, location, and availability. The server 106 stores this data and employs

In an example embodiment, the server 106 obtains data representative of an electric vehicle charging system plug type for an electric vehicle EV, data representative of a current battery charge level for the electric vehicle EV, data representative of a route for the electric vehicle EV, and data representative of a traffic condition for the route. The server 106 selects an available electric vehicle charging station 102 from a plurality of electric vehicle charging stations based on the electric vehicle's EV charging system plug type, the current battery charge level for the electric vehicle, the route for the electric vehicle, and the data representative of a traffic condition for the route. The server 106 schedules a time period for charging the electric vehicle. In an example embodiment, the server 106 sends scheduling data to the selected EVCS 102. This will prevent over booking of the EVCS 102. For example, if an unscheduled vehicle attempts to employ the selected EVCS for a charge prior to a scheduled appointment, the charging time can be limited so that it terminates at or before the scheduled appointment.

In an example embodiment, if there are a plurality of available electric vehicle charging stations that match the input parameters, the server 106 or mobile device 108 can automatically select the selected EVCS. Any suitable criteria can be employed such as price, distance off route, estimated remaining battery power upon reaching the selected EVCS. In another example embodiment, a list of matching EVCS's is provided to the mobile device 108 and the user can select the EVCS.

In an example embodiment, the server 106 determines a range for the electric vehicle EV based on the data representative of current battery charge level for the electric vehicle EV, data representative of the route for the electric vehicle EV, and the data representative of a traffic condition for the route. Alternatively, the mobile device 108 can make the aforementioned determination and communicate them to server 106. The selection of an EVCS 102 by server 106 is further based on the determined range.

In an example embodiment, the server 106, obtaining data representative of a driver rate of consumption history for the electric vehicle EV. The determination of the range of the electric vehicle EV is further based on the driver rate of consumption. This can allow the range calculation to compensate for driving habits of the drive that impact the range (e.g., excessive braking and/or excessive acceleration).

In an example embodiment, the server 106 obtains data representative of a driver rate of consumption history for the electric vehicle EV and correlates the driver rate of consumption with the traffic conditions for the route. The determination of the range of electric vehicle EV is further based on the driver rate of consumption correlated with the traffic conditions for the route ..

In an example embodiment, the server 106 obtains obtaining data representative of weather conditions (e.g., rain, fog, wind, sunrise, sunset) for the route. The determination of the range of the electric vehicle EV is further based on the weather conditions. This can compensate for the effects of temperature and other environmental conditions (such as for example the use of lights and/or wipers) on the performance of the EV's battery.

In an example embodiment, the server 106, obtains data representative of a temperature for the route. The determination of the range of the electric vehicle EV is further based on the temperature. This can compensate on the effects of temperature has on the performance of the battery.

In an example embodiment, the server 106 obtains data representative of a desired rate of charge (e.g. charging level). The selection of an electric vehicle charging station 102 is further based on the desired rate of charge.

In an example embodiment, the server 106 obtains data representative of a loyalty program. The selection of an electric vehicle charging station 102 is further based on the loyalty program. For example, higher priority is given the an EVCS 102 that is associated with a preferred loyalty program. If no EVCS associated with the loyalty program is available, the customer can be provided with the option of either waiting until one becomes available (if there is one in range) or selecting an EVCS that is not associated with the loyalty program.

In an example embodiment, the server 106 obtains data representative of a future departure time. The server 106 determines an estimated arrival times for the plurality of electric vehicle charging stations and selecting the electric vehicle charging station 102 is further based on availability of electrical vehicle charging stations at the estimated arrival times based on the future departure time.

In an example embodiment, the server 106 can obtain data from multiple vehicles and select an EVCS for the vehicles at a common location. For example, if driver #1 (e.g., Ed) wants to meet driver #2 (e.g., Larry) for a snack or beverage and both driver #1 and driver #2 are driving electric vehicles and departing from different locations, can obtain data representative of an electric vehicle charging system plug type for the vehicles, data representative of a current battery charge level for the vehicles, data representative of a routes for the vehicles, and data representative of a traffic conditions for the vehicles. The server 106 determines available electric vehicle charging stations that are within the range of all the vehicles attempting to meet based on the electric vehicle charging system plug types, the current battery charge levels for the electric vehicles, the routes for the electric vehicles, the data representative of a traffic conditions for the route, the electric vehicles. In an example embodiment, the server 106 selects charging stations for the electric vehicles. In another example embodiment, a list of matching electric vehicle charging stations and/or their locations is sent to the mobile devices 108 associated with the electric vehicles and the users (e.g., Ed and Larry) can collaborate in selecting an EVCS 102. For example, driver #1 can select a charging station and/or location, and send the selection to driver #2 who can either agree to the selection or propose another EVCS 102 and/or location. The server 106 schedules a time period for charging the electric vehicles. in an example embodiment, the selected charging station for the electric vehicles are within a predefined proximity of each other, and the scheduled time for the electric vehicles are concurrent. Thus, the owners of the electric vehicles can charge their cars while they meet instead of meeting and then spending additional time charging their vehicles.

In an example embodiment, the server 106 monitors the progress of the EV while the vehicle is enroute to a selected EVCS 102. If the server 106 determines that the electric vehicle EV cannot reach the selected charging station 102 within the scheduled time period, the server 106 re-schedules the time period for charging the electric vehicle EV.

In an example embodiment, the server 106 monitors the progress of the EV while the vehicle is enroute to a selected EVCS 102. If the server determines that the electric vehicle cannot reach the selected charging station within the scheduled time period, the server 106 determines an updated arrival time at the selected vehicle charging station 102. The server 106 determines whether the electric vehicle charging station 102 is unavailable at the updated arrival time. if the server 106 determines that the selected EVCS 102 is unavailable the updated arrival time and/or the EV will be unable to reach the selected EVCS, the server 106 selects a second electric vehicle charging station from the plurality of electric vehicle charging stations that is based on the electric vehicle charging system plug type, the current battery charge level for the electric vehicle, the route for the electric vehicle, the data representative of a traffic condition for the route, and the updated arrival time. In an example embodiment, the server 106 schedules a time period for charging the electric vehicle EV corresponding to the updated arrival time.

In an example embodiment, the server 106 obtains charging cost data from the plurality of electric vehicle charging stations 102. The cost data can include costs for a kilowatt hour (kWh). In particular embodiments the costs can comprise cost per kWh for different levels of charging. The server 106 can further base selecting an EVCS 102 on charging costs.

In an example embodiment, the server 106 provides to the mobile device 108 a list of electric vehicle charging stations based on the electric vehicle charging system plug type, the current battery charge level for the electric vehicle, the route for the electric vehicle, and the data representative of a traffic condition for the route. The mobile device 108 is operable to display the list on a user interface. (not shown, see e.g., FIG. 2) a list of electric vehicle charging stations based on the electric vehicle charging system plug type. The mobile device 108 is operable to receive an input comprising data representative of the selected charging station. The mobile device 108 then communicates data representative of the selection to the server 106. In an example embodiment, the server 106 schedules a time period for charging the electric vehicle EV at the selected EVCS 102.

Although the above examples employ a server 106 for selecting an EVCS 102, those skilled in the art can readily appreciate that in some embodiments, the mobile device 108 performs the functionality descried herein for the server 106 and selects the EVCS. For example, the mobile device 108 can obtain data representative of the capabilities and availability for a plurality of electric vehicle charging stations 102, route information, current battery status and vehicle receptacle configuration and based on the obtained information select a EVCS 102. In particular embodiments, a list of best matches can be displayed on a user interface and a user can select an EVCS 102 from the list of best matches.

FIG. 2 is a block diagram illustrating an example of a mobile device 108 upon which an example embodiment can be implemented. The mobile device 108 comprises mobile device logic 202 that is operable to perform the functionality described herein. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully implemented in software that is embodied on a tangible, non-transitory computer-readable medium that performs the described functionality when executed by processor.

The mobile device 108 further comprises a transceiver 204, which in this example is a wireless transceiver but in some embodiments a wired transceiver is employed. The transceiver 204 is coupled with the mobile device logic 202 and enables the mobile device 108 to communicate via AP 110 with the network 104 and communicate with the server 106. This enables the mobile device to send and receive data with the server 106.

The mobile device 108 further comprises a user interface 206. As will be described in further detail herein, infra, the user interface comprises a display. In an example embodiment as will also be described herein, infra, the user interface 206 further comprises an input device. The display enables the mobile device logic 202 to provide data to a user. The input device allows a user to provide data to the mobile device logic 202.

FIG. 3 is a block diagram illustrating an example of a server 106 suitable for the system of FIG. 1. The server 106 comprises server logic 302 that performs the functionality for the server 106 described herein. The transceiver 304 can be any suitable type of transceiver, wireless or wired, that enables the server 106 to communicate with remote, external devices via a network, such as network 104.

In an example embodiment, the server logic 302 is operable to obtain data from a plurality of electric vehicle charging stations 102 via the transceiver 304. The data from the plurality of electric vehicle charging stations can include, but is not limited to, location, available time periods, and capabilities such as charging capabilities, costs (level or kWh), plug types, number of charging stations at a location, The server logic 302 is further operable to receive a request for selecting a charging station for an electric vehicle that comprises data for selecting an electric vehicle charging station. The data for selecting an EVCS for charging an electric vehicle may include but is not limited to location, route, current battery level and capacity, plug type, desired rate of charge or charging level, driver data, current traffic conditions along route, temperature, weather and/or environmental conditions, loyalty program information, and expected departure time via the transceiver 304. The server logic 302 is operable to select a charging station on any one or more of the aforementioned data for charging an EV. In an example embodiment, the server logic 302 schedules an appointment for the EV and sends the scheduled appointment via the transceiver 304 to the selected EVCS.

In an example embodiment, the server 106 n an example embodiment, the server logic 302 selects a group of available electric vehicle charging stations and via the transceiver 304 provides a list of the group to a mobile device and receives a selected charging station from the list from the mobile device. In particular embodiments the server logic 302 can select a different (i.e., second) charging station upon determining the electric vehicle cannot reach the selected EVCS during a scheduled time period or the battery no longer has sufficient capacity to reach the selected EVCS.

In an example embodiment, the server 106 In yet another example embodiment, the server logic 302 can obtain data for a plurality of electric vehicles that desire to meet at a location with sufficient charging stations to accommodate the plurality of electric vehicles, or where there are sufficient electric vehicle charging stations nearby that is within the range of the electric vehicle charging stations. The server logic 302 can automatically select a location (or a plurality of electric vehicle charging stations) or can provide a list of locations (or electric vehicle charging stations) via transceiver 304 to mobile devices associated with the plurality of electric vehicles and receive a selection, or selections, from the mobile devices and in particular embodiments schedule appointments accordingly.

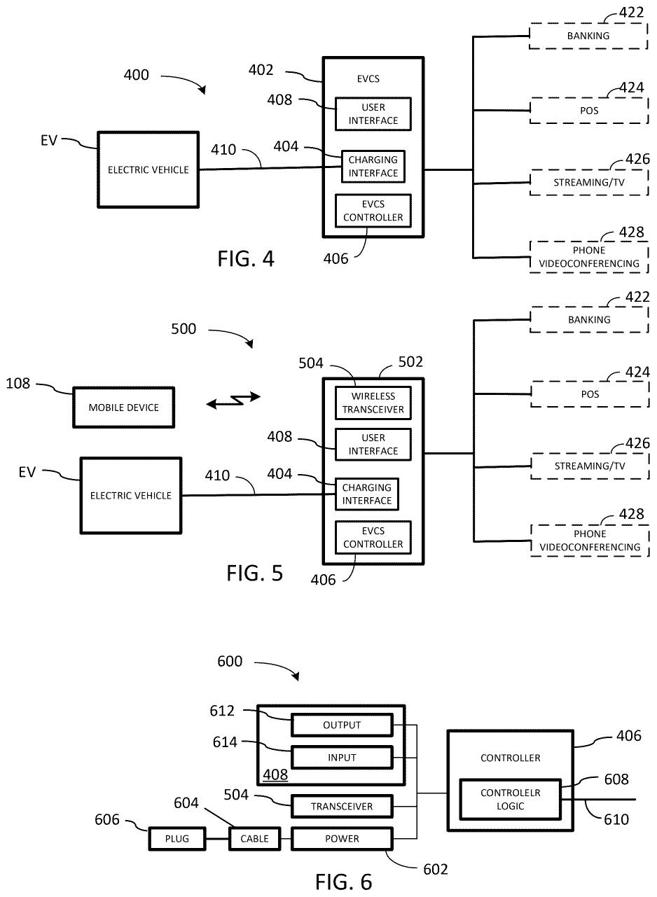

FIG. 4 is a block diagram illustrating an example of a system 400 comprising an electric vehicle EV coupled with an electric vehicle charging station EVCS 402 upon which an example embodiment can be implemented. In an example embodiment, the EVCS 402 is operable to perform the functionality of EVCS 102 described in FIGS. 1 and 3.

The EVCS 402 comprises a charging interface 404, an EVCS controller 406, and a user interface 408. The charging interface 404 is coupled with the electric vehicle EV via a connector 410. In an example embodiment, the connector 410 comprises a conductor with a plug at the end that is connected to the electric vehicle EV. The electric vehicle EV comprises a receptacle that is configured to mate with the plug at the end of the connector 410.

The EVCS controller 406 is coupled with the charging interface 404 and comprises logic for performing the functionality described herein. The EVCS controller 406 is provided with data representative of the type of plug coupled with connector 410 and the rate of charge (e.g., levels) available from the charging interface 404. The EVCS controller 406 is operable to control the operation of the Charging Interface 404, such as for example, switching the Charging Interface on (provide power via connector 410) or off, and rate of charge (or charge level).

The user interface 408 is coupled with the EVCS controller 406 and provides a user with a way to interact with the EVCS 402. For example, the user interface 408 can be employed to authenticate a user, pay for services, and/or specify charging parameters (e.g., rate of charge and for how long). In an example embodiment, the user interface 408 comprises an output device, such as for example, a display, an audio output (e.g., a speaker or input jack for headphones), or other suitable device for providing information to a user. In another example embodiment, the user interface 408 comprises an input device enabling a user to provide information to the EVCS controller 406, such as a user authentication devices (e.g., card reader which can include a magnetic stripe reader, chip reader, and/or a Near Field Connection (NFC) interface) and PIN (personal identification number) PAD, touch screen audio device (e.g., microphone), and/or optical device (e.g., a scanner such as a barcode reader or a scanner with optical character recognition (OCR).

In an example embodiment, a user employs the user interface 408 to authenticate with the EVCS. Part of the authentication process can include paying for charging services. Upon successfully authenticating, electric power is provided to the electric vehicle EV by the EVCS 402 employing the charging interface 404 and connector 410.

In an example embodiment, the EVCS 402 is coupled with an automated banking machine, such as an automated teller machine (ATM) 422. The user can request a financial transaction via the user interface 408. For example, the user interface 408 can provide an input to select for performing banking transactions.

The user's banking information is authenticated. The user can employ a separate (or different) authentication (e.g., card & PIN) for the banking transaction than is used charging the electric vehicle. Upon successfully authenticating the user's banking information, a financial transaction is conducted.

In an example embodiment, the financial transaction is a cash withdrawal for a requested amount of cash (that is input via the user interface 408) from an account. The user interface 408 further comprises a cash dispenser or a cash recycler for providing the requested amount of cash to the user.

In an example embodiment, the financial transaction is for a deposit into a financial account. The deposit can be cash and/or checks. The user interface 408 further comprises a deposit device that is either a cash deposit device, check deposit device, and/or a cash recycler. The user inserts the deposit item into the cash deposit device and upon authenticating the deposit item, the financial account is credited for the amount of the deposit item.

In an example embodiment, the EVCS 402 is coupled with a Point of Sale (POS) system 424 and is operable to allow a user to purchase retails goods via the user interface 408 of the EVCS 402. The POS 424 offers a plurality of retail items for sale at the electric vehicle charging station 402. Examples of retail items include, but are not limited to beverages (such as soft drinks, coffee, tea, milk, and/or bottled water), food (e.g., snacks such as chips, pretzels, fruit), air (to fill tires), small hand tools (such as screwdrivers), or any other item a vendor wishes to sell that fits in the space provided. The goods can be displayed in locked compartments, or displayed on the user interface.

The user interface 408 can be employed to submit a request to purchase a selected one of the plurality of retail items. In some embodiments, multiple embodiments can be selected. Upon completion of selecting the items, the user is provided with a purchase price. The user can employ the user interface 408 for paying for the selected items. The user interface can be configured to accept cash, credit cards, and/or payments from third party payment service (such as PayPal or Venmo).

Upon receipt of payment for the selected items, the EVCS 402 can communicate the selected items to the POS 424. The POS can provide the selected items to the user via any suitable technique. For example, the items can be retrieved from the POS 424 and placed in a designated area of the user interface. As another example, a door where a selected item is located can be unlocked. Still another example, the item can be moved to a designated area by the POS 424 and a door or other access mechanism can be unlocked allowing the user to retrieve the item from the designated area.

In an example embodiment, the EVCS 402 is coupled with a streaming and/or television service system 426 and is operable to provide streaming and/or television services. Thus, a user can watch television and/or catch up on a favorite show while waiting for their vehicle to charge (and in some embodiments purchase popcorn from the POS 424 too).

The user selects an input on user interface 408 to request steaming or television services. Optionally, the user can employ the user interface 408 to pay for the requested service. For example, the user interface 408 can be equipped with a cash acceptor, cash recycler, credit card reader, or be configured to accept payments from third party payment providers for the requested service. In an example embodiment, the EVCS controller 406 can limit the length of time the service is provided to the time period the electric vehicle is being charged. The requested service can be provided on audio and/or visual output devices on the user interface 408.

In an example embodiment, the EVCS 402 is coupled with a phone and/or videoconference system 428. This can be useful in providing phone, data, videoconferencing access in areas where cellular and/or internet services are weak or non-existent.

The user selects an input on user interface 408 to request phone, data, or videoconferencing services. Optionally, the user can employ the user interface 408 to pay for the requested service. For example, the user interface 408 can be equipped with a cash acceptor, cash recycler, credit card reader, or be configured to accept payments from third party payment providers for the requested service. In an example embodiment, the EVCS controller 406 can limit the length of time the service is provided to the time period the electric vehicle is being charged. The requested service can be provided on audio and/or visual input and output devices on the user interface 408.

FIG. 5 is a block diagram illustrating an example of a system 500 comprising an electric vehicle EV coupled with an electric vehicle charging station 502 and a mobile, wireless device 108 communicating with the electric vehicle charging station 502. In an example embodiment, the electric vehicle charging station 502 is configured with the some or all of the same components as EVCS 402 and further comprises a wireless transceiver 504 for communicating with the mobile device 108. The wireless transceiver can be any suitable type of wireless device that can communicate via any suitable protocol such as for example WIFI and/or BLUETOOTH. As will be further described herein infra, the connection between the mobile device 108 and wireless transceiver 504 can allow for other services to be conducted via the mobile device 108.

In an example embodiment, the mobile device 108 is employed for requesting charging services from the EVCS 502. The request can include rate of charge (e.g., Level) and amount of time or amount of electricity for charging the EV. In particular embodiments, payment data can be received by the EVCS 502 from the mobile device 108 via the wireless transceiver 504.

In an example embodiment, the user can employ the mobile device 108 to communicate with the automated banking machine 422 for conducting financial transactions. The type of transaction (withdrawal or deposit), amount, account can be input into the mobile device and provided to the automated banking machine 422 via the wireless transceiver 504 of EVCS 502. In particular embodiments, the mobile device 108 can receive confirmation of a transaction from the automated banking machine 422 from the EVCS 502 via the wireless transceiver 504.

In an example embodiment, the user can employ the mobile device 108 to communicate with the POS system 424. For example, the available goods can be displayed on a display (see e.g., output 612 in FIG. 6) on the mobile device 108 and the user can select items via the mobile device's user interface. In particular embodiments, the mobile device 108 can be employed to pay for the selected items. Payment data can be sent to the POS system 424 via the wireless transceiver 504 of the EVCS 502.

In an example embodiment, the user can employ the mobile device 108 to communicate with the Streaming/TV system 426 to obtain streaming and/or television service. For example, the available services (such as channels or shows) can be displayed on a display (see e.g., output 612 in FIG. 6) on the mobile device 108 and the user can select items via the mobile device's user interface. In particular embodiments, the mobile device 108 can be employed to pay for the selected services. Payment data can be sent to the Streaming/TV system 426 via the wireless transceiver 504 of the EVCS 502. In some embodiments, the requested streaming and/or TV service can be output on the mobile device 108 via the wireless transceiver 504. In particular embodiments, multiple mobile devices 108 can be in communication with wireless transceiver 504 which can have separate connections wo the wireless transceiver 504 and receive separate streams and/or television programming from Streaming/TV system 426. This can be beneficial where multiple occupants are waiting for an electric vehicle to charge. In particular embodiments, if the requested content is longer than the time for charging the electric vehicle EV, the user will be presented with the option to download the content onto mobile device 108. The user can then view the content while waiting for the electric vehicle EV to charge and upon completion of charging, the user can watch the remainder of the content at a later time.

In an example embodiment, the user can employ the mobile device 108 to communicate with the Phone/videoconferencing system 428 to obtain pone and/or videoconferencing service. For example, the available services (such as phone or videoconferencing) can be displayed on a display (see e.g., output 612 in FIG. 6) on the mobile device 108 and the user can select items via the mobile device's user interface. In particular embodiments, the mobile device 108 can be employed to pay for the selected services. Payment data can be sent to the Phone/Videoconferencing system 428 via the wireless transceiver 504 of the EVCS 502. In some embodiments, the requested phone and/or videoconferencing service can be output on the mobile device 108 via the wireless transceiver 504. In particular embodiments, multiple mobile devices 108 can be in communication with wireless transceiver 504 which can have separate connections with the wireless transceiver 504 and receive separate phone and/or videoconferencing services from Phone/Videoconferencing system 428. This can be beneficial where multiple occupants are waiting for an electric vehicle to charge.

In an example embodiment, the EVCS 402, 502 can be employed for one-stop shopping. For example, one or more of the Banking machine 422, POS 424, Streaming or TV service, and Phone/Videoconferencing 428 terminals are located remotely from the EVCS (either EVCS 402 in FIG. 4 or EVCS 502 in FIG. 5). A user can employ either the user interface 408 (FIG. 4 or FIG. 5) or a mobile device 108 coupled with wireless transceiver 504 to conduct or pre-establish transactions. For example, the user can request a cash withdrawal from the Banking machine 422 and purchase items from the POS 424 and pay for the purchase at the EVCS 402, 502. The user can then pick up the cash and/or purchased items. In particular embodiments, the customer is provided with a token, QR code, or other identifying information to verify the transaction when they pick up the cash and/or purchase.

In an example embodiment, facial recognition and/or other biometric data, such as for example fingerprints can be employed to streamline the purchase process. For example, EVCS controller can have access to a database with facial and/or biometric data for the user of the EVCS 402 or 502. Alternatively, the user's face can be scanned while conducting the transaction and/or the user can be asked to provide a fingerprint for scanning. When the user goes to the banking machine 422 or POS 424, facial recognition and/or biometric technology can be employed to identify the user, allowing the user to obtain their cash without providing a banking card and/or token to the banking machine 422 and/or bypass checkout at the POS 424.

FIG. 6 is a block diagram illustrating an example of an electric vehicle charging station 600 upon which an example embodiment can be implemented. The EVCS 600 can be employed to implement the EVCS 502 illustrated in FIG. 5,

In an example embodiment, the EVCS 502 comprises a power source 602 and a cable 604 with a plug 606 coupled with the power source 602. This configuration is suitable for implementing the connector 410 described in FIGS. 4 and 5. The power source 602 provides the electricity for charging an electric vehicle coupled with the plug 606. In an example embodiment, a plurality of cables 604 with plugs 606 different plug types are coupled with the power source 602. This can enable the EVCS 600 to provide charging to a wider variety of electric vehicles.

In an example embodiment, a controller 406 is coupled with the source of power 602. The controller comprises controller logic 608 which provides the functionality described herein for the controller 406. In an example embodiment, the controller logic 608 is operable to control the electricity provided to an electric vehicle by the power source 602. For example, the controller logic 608 can switch the power source 602 on or off and control the rate of charge provided to an electric vehicle.

In an example embodiment, a link 610 is coupled with controller logic 608 and can be employed to provide additional services by EVCS 600. The link 610 can be any suitable wired, wireless, or combination of wired and wireless links. For example, the link 610 can be employed to communicate with a automated banking machine 422 (FIGS. 4 & 5), POS system 424 (FIGS. 4 & 5), Streaming/TV system 426 (FIGS. 4 & 5), and/or a Phone/Videoconference system 428 (FIGS. 4 & 5),

In an example embodiment, the wireless transceiver 504 is coupled with the controller 406. This can allow the control logic to send and receive information from a mobile device (e.g., mobile device 108 illustrated in FIGS. 1, 2, 4, 5). This can allow a user to employ a mobile device to request and pay for electric vehicle charging services and/or specify the parameters for charging the electric vehicle (e.g., rate of charge, amount of time and/or kWh of electricity).

In an example embodiment, the user interface 408 is coupled with the controller 406. The user interface 408 can be employed by a user to request electric vehicle charging services and/or other services such as banking, POS, Streaming/TV, and/or Phone/Videoconferencing where available.

In an example embodiment, the user interface comprises an output (e.g., a display or a speaker) 612 for providing information to a user. The input device can be any one or any combination of a visual device (e.g., monitor or display screen, and/or lights to direct the user's attention to a portion of the user interface 408), audio device (e.g., a speaker a speaker jack to provide audio signals to a headphone), or a haptic device.

In an example embodiment, the user interface comprises an input device 614. The input device 614 enables a user to provide information to the controller 406, such as, for example, to request electric vehicle charging services and/or other services such as banking, POS, Streaming/TV, and/or Phone/Videoconferencing where available, to specify the parameters of the requested service (e.g., rate of charge and amount of charge (time or kWh)), account and amount of a transaction, audio, video, or audiovisual content, or connection data for a phone call or videoconference. The input device can be any one or any combination of a keypad, PIN Pad, keyboard, touch screen, or microphone.

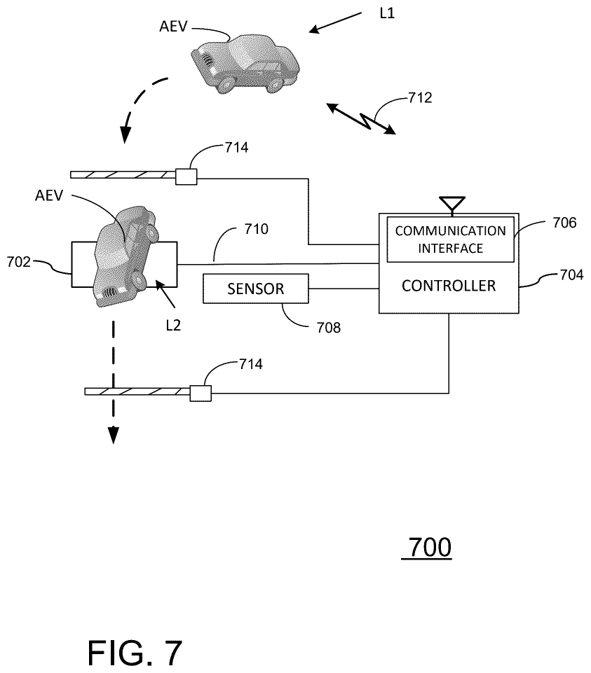

FIG. 7 is a block diagram illustrating an example of an electric vehicle wireless (for example inductive) charging system 700 that employs a wireless charter 702, such as for example an in-ground wireless charging pad. The system 700 can be employed in a parking area (e.g., garage or lot) which can obviate the need for installing a plug-in type electric vehicle charging station at every parking space.

In the illustrated example, the wireless charger 702 is an in-ground wireless charger that charges a battery powered electric vehicle when the vehicle is in a particular location with respect to the in-wireless charger, such as on top of the in-ground wireless charger. An in-ground wireless charger was merely chosen for ease of illustration and those skilled in the art can readily appreciate that wireless charger 702 can be any suitable type of charger. The wireless charger 702 is coupled with a controller 704. The controller 704 is coupled with a communication interface 706 that can be integrated into the controller as illustrated in FIG. 7 or in other embodiments is a separate component. The controller 704 communicates with the wireless charger 702 via link 710. Link 710 can be any suitable type of communication link, such as for example a wired link, a wireless link, or a combination of wired and wireless links. The controller 704 employs link 712 to communicate with an autonomous, electric vehicle AEV. In this example, the autonomous electric vehicle can move to different locations without a human driver.

The wireless charger 702, can one or more be any suitable devices that can wirelessly charge an electric vehicle, such as an in-ground wireless charger. In an example embodiment, modular pads can be employed. As those skilled in the art can readily appreciate, the number modular pads employed can depend on the size, capacity, and/or number of batteries in the electric vehicle. Although the system 700 is described as being employed for charging autonomous, electric vehicles, those skilled in the art can readily appreciate that wireless charger 702 can be employed to charge any battery type electric vehicle, including non-autonomous electric vehicles.

The controller 704 comprises logic for controlling the operation of the wireless charger 702 and performing the functionality described herein. In an example embodiment, the controller 704 is operable to switch the wireless charger on and off. In another example embodiment, the controller 704 controls the operating parameters of the wireless charger 702, such as for example, amount of power, waveform, and/or frequency of wireless signal transmitted by the wireless charger 702.

In an example embodiment, the system 700 further comprises a sensor 708 that is coupled with the controller 704. The sensor 708 can be employed to detect when a car is in position with respect to the wireless charger 702, thus enabling the controller 704 to operate the wireless charger 702 when an autonomous, electric vehicle AEV is present, and can switch the wireless charger off when no vehicle is present.

In an example embodiment, the controller obtains charging data from the autonomous, electric vehicle AEV via link 712. The charging data may include, but is not limited to data identifying the autonomous, electric vehicle AEV, current battery charge level, amount of charge requested, time period vehicle is available for charging, and/or the autonomous electric vehicle's AEV current location, which in the illustrated example is L1.

The controller 704 scheduled a time period for charging the autonomous, electric vehicle AEV with the wireless charger 702, which in the illustrated example is at location L2. In an example embodiment, the scheduled time period is based in part on the charging data provided by the autonomous, electric vehicle AEV.

In an example embodiment, the controller 704 receives rate data from the source of the electricity, e.g., a utility. The controller is operable to schedule the time period for charging the autonomous, electric vehicle AEV based in part on the rate data. For example, the controller 704 can schedule an available time period with the lowest rate when the vehicle is available for charging. For example, because usage is usually lower in early morning hours (for example 1 am-5 am), the utility rates for that time period are lower. The controller 704 can select a time period when the utility rates are lower, and in particular embodiments, at the lowest rate having an available time period that is at least as long as the desired time period for charging the autonomous, electric vehicle AEV ..

The controller 704 signals the autonomous, electric vehicle AEV to cause the electric vehicle to move from it's current location, L1, to the location of the in-ground wireless electric charger 702 at location L2. There are multiple ways that this can be accomplished. For example, at the appropriate time (e.g., at the start of the scheduled time which in particular embodiments includes travel time), the controller 704 signals the autonomous, electric vehicle AEV to move from its current location, L1, to L2. The controller 704 may include route data for the autonomous, electric vehicle AEV to travel from L1 to L2. In other embodiments, the controller 704 provides the coordinates for L2 and autonomous, electric vehicle AEV determines the route. As another example, the controller 704 provides data representative of the time period and the location of the wireless charger 702, L2, which in particular embodiments includes route guidance. At the appropriate time (which may also include travel time), the autonomous, electric vehicle AEV automatically drives itself from L1 to L2.

In an example embodiment, the controller is operable to communicate with the autonomous, electric vehicle to verify that it is the vehicle at the wireless charger 702. In particular embodiments, the system 700 further comprises a gate or other type of barricade 714 that enables the controller 704 to limit access to the wireless charger 702.

At the expiration of the time period, or upon completion of charging the autonomous, electric vehicle AEV, the controller 704 signals the autonomous, electric vehicle AEV, causing the autonomous, electric vehicle AEV to move away from the wireless charger 702. For example, the autonomous, electric vehicle AEV can be instructed to return to its original location, L1, or can be provided with another location. Although in the illustrated example the electric car is illustrated as moving forward from the wireless charger 702, those skilled in the art can readily appreciate that the autonomous, electric vehicle AEV may back out instead. For example, when L2 is located adjacent to a wall in a parking garage,

In an example embodiment, logic in the autonomous electric vehicle is operable to select the charging time and move the autonomous electric vehicle to the wireless charger 702 at the appropriate time and move the autonomous electric vehicle off of the wireless charger 702 when completed. For example, the controller 704 can provide the autonomous electric vehicle AEV with available times for scheduling. In particular embodiments, the controller 704 receives rate data from the source of the electricity, e.g., a utility. In one embedment, the controller 704 is operable to send the rate data to the autonomous electric vehicle to allow it to consider rate data in selecting a time period. In another embodiment, the time periods available that are sent to the autonomous electric vehicle AEV are limited to the time periods with the lowest rates.

At the appropriate time, the autonomous electric vehicle AEV moves from it's current location, L1, to the location of the in-ground wireless electric charger 702 at location L2. In an example embodiment, the controller is operable to communicate with the autonomous, electric vehicle to verify that it is the vehicle at the wireless charger 702. In particular embodiments, the system 700 further comprises a gate or other type of barricade that enables the controller 704 to limit access to the wireless charger 702.

At the expiration of the time period, or upon completion of charging the autonomous, electric vehicle AEV moves away from the wireless charger 702. For example, the autonomous, electric vehicle AEV can be instructed to return to its original location, L1, or can be provided with another location by controller 704.

As those skilled in the art can readily appreciate, other factors can be employed in selecting a time period for scheduling charging the autonomous, electric vehicle AEV on in-grond wireless charger 702. For example, the time period the autonomous, electric vehicle AEV will be parked at L1. This data can be entered by the driver of the autonomous, electric vehicle AEV in the process of parking the car and/or the controller 704 can determine an estimated departure time for the autonomous, electric vehicle AEV from historical data for the autonomous, electric vehicle AEV's that includes departure times from the parking area. In another embodiment, factors such as whether the autonomous, electric vehicle AEV is associated with a preferred customer and/or the amount of charging time requested are considered.

In an example embodiment, the time period for charging the autonomous electric vehicle is less than the time period for fully charging the electric vehicle. For example either the controller 704 or the autonomous electric vehicle can determine a an amount of charge the vehicle would need for a time period (e.g., the next day). This determination can be based on scheduled route, weather, driving habits of driver, and/or expected traffic conditions on route. In an example embodiment, the amount of charge further comprises an additional charge that includes a cushion or time period for unexpected delays or unexpected changes to the route. This feature can be useful in fleet, or other, charging situations where a limited number of chargers are available for charging a plurality of vehicles, thus enabling the chargers to minimize the amount of time vehicles are being charged in order to be better able to charge more vehicles in a time period.

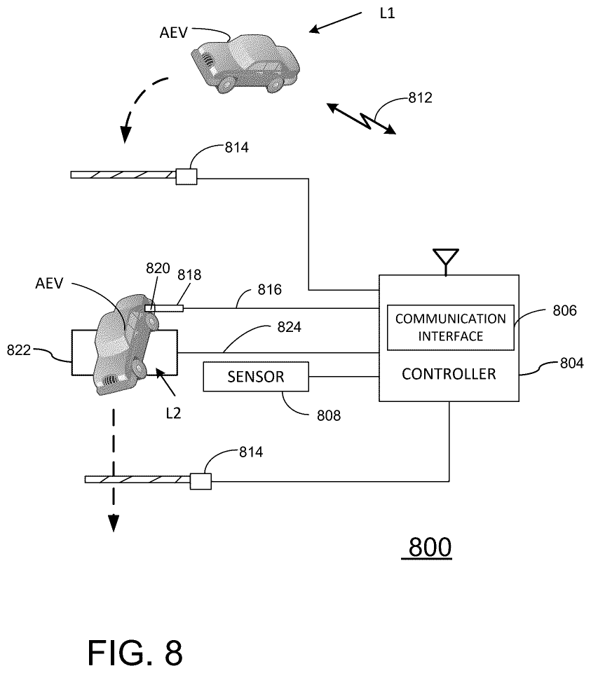

FIG. 8 is a block diagram illustrating an example of charging an electric vehicle charging system (EVCS) 800 for autonomous electric vehicles (AEV) that employs a wired connection. The EVCS 800 can be employed in any type of parking area (e.g., garage or lot) which can obviate the need for installing a plug-in type electric vehicle charging station at every parking space.

The controller 804 comprises logic for controlling the operation of the EVCS 800 and performing the functionality described herein. In an example embodiment, the controller 804 is operable to switch the power of he EVCS on and off. In another example embodiment, the controller 804 controls the operating parameters of the wireless charger 802, such as for example, amount of power, waveform, and/or frequency of wireless signal transmitted by the wireless charger 802.

In an example embodiment, the system 800 further comprises a sensor 808 that is coupled with the controller 804. The sensor 808 can be employed to detect when a car is in position for charging. For example, the sensor 808 can be employed for aligning the AEV charging interface (e.g., receptacle and/or plug) 820 with the EVCS interface (e.g, plug and/or receptacle) 818 so that the connector 816 can provide power for charging the AEV.

In an example embodiment, the controller 804 sends signals to the AEV to align the AEV's charging interface 820 with the EVCS charging interface 818. For example, the controller 804 can send signals instructing the AEV to move forward or backward for the proper alignment. Once aligned, the controller 804 can cause the link 816 and EVCS charging interface 818 to move in order couple the EVCS charging interface 818 with the AEV charging interface 820. Once the EVCS charging interface 818 and AEV charging interface 820 are coupled, the AEV can be charged.

In an example embodiment, the AEV parks on a movable surface (such as for example a pad, palette, or dolly) 822. The controller 804 employs link 824 to move the movable surface 822 to align the AEV charging interface 820 with the EVCS charging interface 818. Once aligned, the controller 804 can cause the link 818 and EVCS charging interface 818 to move in order couple the EVCS charging interface 818 with the AEV charging interface 820. Once the EVCS charging interface 818 and AEV charging interface 820 are coupled, the AEV can be charged.

In an example embodiment, the controller obtains charging data from the autonomous, electric vehicle AEV via link 812. The charging data may include, but is not limited to data identifying the autonomous, electric vehicle AEV, current battery charge level, amount of charge requested, time period vehicle is available for charging, and/or the autonomous electric vehicle's AEV current location, which in the illustrated example is L1.

The controller 804 scheduled a time period for charging the autonomous, electric vehicle AEV with the wireless charger 802, which in the illustrated example is at location L2. In an example embodiment, the scheduled time period is based in part on the charging data provided by the autonomous, electric vehicle AEV.

In an example embodiment, the controller 804 receives rate data from the source of the electricity, e.g., a utility. The controller is operable to schedule the time period for charging the autonomous, electric vehicle AEV based in part on the rate data. For example, the controller 804 can schedule an available time period with the lowest rate when the vehicle is available for charging. For example, because usage is usually lower in early morning hours (for example 1 am-5 am), the utility rates for that time period are lower. The controller 804 can select a time period when the utility rates are lower, and in particular embodiments, at the lowest rate having an available time period that is at least as long as the desired time period for charging the autonomous, electric vehicle AEV.

The controller 804 signals the autonomous, electric vehicle AEV to cause the electric vehicle to move from it's current location, L1, to the location for alignment with the EVCS 800 at location L2. There are multiple ways that this can be accomplished. For example, at the appropriate time (e.g., at the start of the scheduled time which in particular embodiments include travel time), the controller 804 signals the autonomous, electric vehicle AEV to move from its current location, L1, to L2. The controller 804 may include route data for the autonomous, electric vehicle AEV to travel from L1 to L2. In other embodiments, the controller 804 provides the coordinates for L2 and autonomous, electric vehicle AEV determines the route. As another example, the controller 804 provides data representative of the time period and the location of the wireless charger 802, L2, which in particular embodiments include route guidance. At the appropriate time (which may also include travel time), the autonomous, electric vehicle AEV automatically drives itself from L1 to L2.

In an example embodiment, the controller is operable to communicate with the autonomous, electric vehicle to verify that it is the vehicle at location L2. In particular embodiments, the system 800 further comprises a gate or other type of barricade 814 that enables the controller 804 to limit access to the wireless charger 802.

At the expiration of the time period, or upon completion of charging the autonomous, electric vehicle AEV, the controller 804 signals the autonomous, electric vehicle AEV, causing the autonomous, electric vehicle AEV to move away from the location L2. For example, the autonomous, electric vehicle AEV can be instructed to return to its original location, L1, or can be provided with another location. Although in the illustrated example the electric car is illustrated as moving forward from the wireless charger 802, those skilled in the art can readily appreciate that the autonomous, electric vehicle AEV may back out instead. For example, when L2 is located adjacent to a wall in a parking garage,

In an example embodiment, logic in the autonomous electric vehicle is operable to select the charging time and move the autonomous electric vehicle to location L2 at the appropriate time and move the autonomous electric vehicle off away from L2 when completed. For example, the controller 804 can provide the autonomous electric vehicle AEV with available times for scheduling. In particular embodiments, the controller 804 receives rate data from the source of the electricity, e.g., a utility. In one embedment, the controller 804 is operable to send the rate data to the autonomous electric vehicle to allow it to consider rate data in selecting a time period. In another embodiment, the time periods available that are sent to the autonomous electric vehicle AEV are limited to the time periods with the lowest rates.

At the appropriate time, the autonomous electric vehicle AEV moves from it's current location, L1, to location L2. In an example embodiment, the controller is operable to communicate with the autonomous, electric vehicle to verify that it is the vehicle at location L2. In particular embodiments, the system 800 further comprises a gate or other type of barricade 814 that enables the controller 804 to limit access to location L2.

At the expiration of the time period, or upon completion of charging the autonomous, electric vehicle AEV moves away from location L2. For example, the autonomous, electric vehicle AEV can be instructed to return to its original location, L1, or can be provided with another location by controller 804.

As those skilled in the art can readily appreciate, other factors can be employed in selecting a time period for scheduling charging the autonomous, electric vehicle AEV at EVCS 800. For example, the time period the autonomous, electric vehicle AEV will be parked at L1. This data can be entered by the driver of the autonomous, electric vehicle AEV in the process of parking the car and/or the controller 804 can determine an estimated departure time for the autonomous, electric vehicle AEV from historical data for the autonomous, electric vehicle AEV's that includes departure times from the parking area. In another embodiment, factors such as whether the autonomous, electric vehicle AEV is associated with a preferred customer and/or the amount of charging time requested are considered. In an example embodiment, other considerations include the configuration or type of the AEV's plug and/or receptacle. In some embodiments, the controller 804 is operable to change the EVCS's interface 818 to match the AEV's interface 820. In other embodiments, where there are a plurality of EVCS 800, the AEV is matched with an EVCS 800 that has the appropriate interface 818 to couple with the AEV's interface 820.

In an example embodiment, the time period for charging the autonomous electric vehicle is less than the time period for fully charging the electric vehicle. For example either the controller 804 or the autonomous electric vehicle can determine a an amount of charge the vehicle would need for a time period (e.g., the next day). This determination can be based on scheduled route, weather, driving habits of driver, and/or expected traffic conditions on route. In an example embodiment, the amount of charge further comprises an additional charge that includes a cushion or time period for unexpected delays or unexpected changes to the route. This feature can be useful in fleet, or other, charging situations where a limited number of chargers are available for charging a plurality of vehicles, thus enabling the chargers to minimize the amount of time vehicles are being charged in order to be better able to charge more vehicles in a time period.

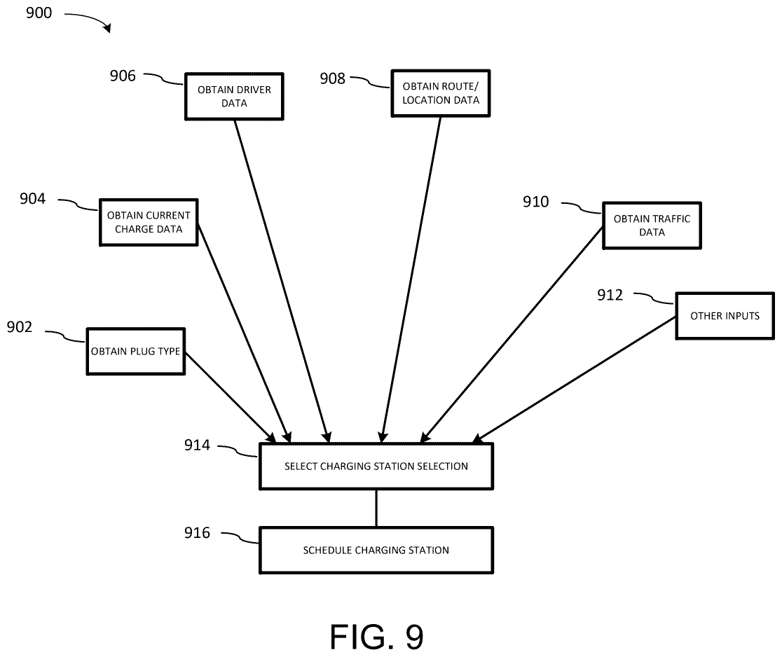

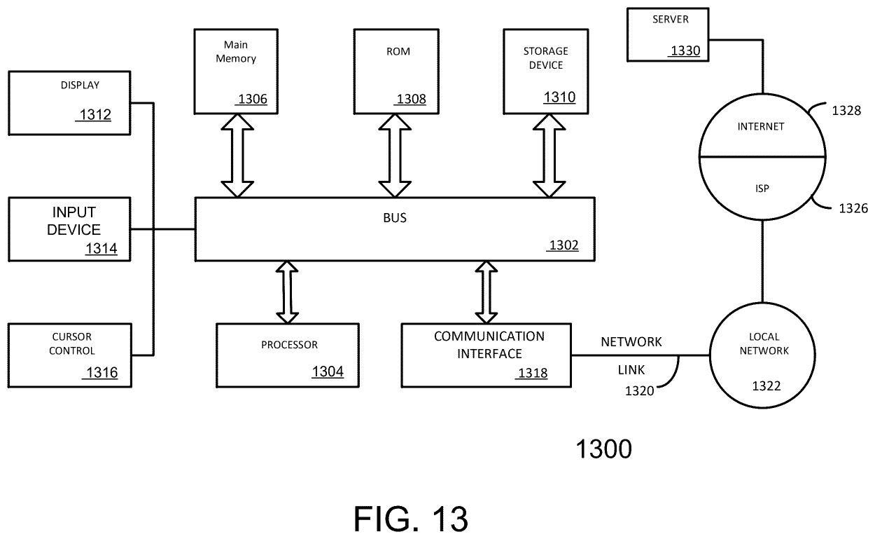

FIG. 9 is a block diagram illustrating an example of a method 900 for selecting an electric vehicle charging station. The methodology 900 can be implemented by any one or combination of the mobile device (FIGS. 1-3 and 5-6), the server 106 (FIG. 1), the mobile device logic 202 (FIG. 2), server logic 302 (FIG. 3), or computer system 1300 (FIG. 13).

At 902, a plug type for the electric vehicle to be charged is obtained. This information can be manually input by a user or stored in a database that associates the plug type with the electric vehicle to be charged.

At 904, the current charge data is obtained. This is a measurement of the amount of charge the electric vehicle's battery has remaining. This data can be employed to determine the range of the electric vehicle.

At 906, data for the driver of the electric vehicle is obtained. Since driving habits can affect the range of the electric vehicle, this information can be employed for determining the range of the electric vehicle. If the electric vehicle does not maintain data per driver, composite driver data can be employed.

At 908, route and/or location data is obtained for the electric vehicle. If a route has not already been determined, the location and destination of the electric vehicle can be obtained and the route can be determined. In an example embodiment, more than one route can be calculated and provided to a mobile device (e.g., mobile device 108) and the user can select the route. Route changes due to accidents, construction, or other detours can be obtained while the vehicle is enroute and can be employed to update the route data.

At 910, traffic conditions for the route are obtained. This act can occur concurrently with 908 and can be employed to determine the route for the electric vehicle. Traffic data can include, but is not limited to, traffic control devices on the route, traffic congestion, other things that can impact the amount of time to travel a route such as accidents, construction, or other hazards.

At 912, other inputs (data) can be obtained for selecting an EVCS. Examples of other data include, but are not limited to, temperature and other weather or environmental conditions, desired rate (or Level) or charge, loyalty program information, future departure time, and/or data for collaborating (e.g., meet) with a second vehicle (e.g., the second electric vehicle's location, range, plug type, desired rate (or Level) of charge, or any other factors described herein).

At 914, an EVCS is selected. In an example embodiment, the EVCS is selected is based on the electric vehicle charging system plug type, the current battery charge level for the electric vehicle, the route for the electric vehicle, and the data representative of a traffic condition for the route. In some embodiments, the range for the electric vehicle based on the data representative of current battery charge level for the electric vehicle, data representative of the route for the electric vehicle, and the data representative of a traffic condition for the route is determined and selecting an EVCS is further based on the determined range. In an example embodiment, determining the range of the electric vehicle is further based on the driver rate of consumption. In another example embodiment, determining the range of the electric vehicle is further based on the habits of the driver. In yet another example embodiment, the driver rate of consumption with is correlated with the traffic conditions for the route and determining the range of electric vehicle is further based on the driver rate of consumption correlated with the traffic conditions for the route. In another example embodiment, determining the range of the electric vehicle is further based on the weather conditions. In yet another example embodiment, determining the range of the electric vehicle is further based on the temperature. In still yet another example embodiment, selecting the electric vehicle charging station is further based on the desired rate of charge. In some example embodiments selecting the electric vehicle charging station is further based on the loyalty program. In some other example embodiments, an estimated arrival time for a plurality of electric vehicle charging stations is determined and the selection of an electric vehicle charging station is further based on availability of the electrical vehicle charging station at the estimated arrival time based on the future departure time.

In an example embodiment, an EVCS is selected at a location where a plurality of vehicles can collaborate and concurrently charge. The selected EVCS is within a predefined proximity of EVCSs selected for the other of the plurality of electric vehicles.

In an example embodiment, a list of electric vehicle charging stations is provided to a user. An input can be received from the user indicating a selection of an EVCS from the list. In another embodiment, a server can automatically select an EVCS based on criterion such as price, distance to route, estimated remaining battery power upon arrival, or any other suitable criterion.

At 916, a time period is scheduled for charging the electric vehicle at the selected electric vehicle charging station. In an example embodiment, an arrival time for the electric vehicle is calculated and the scheduled time period is on or after the determined arrival time.

In an example embodiment, data representative of the scheduled time period is provided to the selected EVCS which reserves the time slot for the electric vehicle. If another electric vehicle arrives at the selected EVCS prior to the scheduled arrival time of the EVCS, the earlier arriving vehicle will only be allowed to charge until the scheduled arrival time of the scheduled electric vehicle. In particular embodiments, authentication data such as a code can be provided to the scheduled electric vehicle to prevent other vehicles from using the EVCS during the scheduled time period. For example, a PIN, token (which can be sent via a WIFI or NFC link), or a barcode, such as a Quick Response (QR) code can be provided to the electric vehicle.

In an example embodiment, the progress of the electric vehicle is monitored and a determination can be made whether the electric vehicle can reach the selected charging station within the scheduled time period. If the electric vehicle cannot reach the EVCS for the scheduled time period, the time period for charging the electric vehicle is re-scheduled.

In an example embodiment, the progress of the electric vehicle is monitored and a determination can be made whether the electric vehicle can reach the selected charging station within the scheduled time period. If the electric vehicle cannot reach the selected EVCS for the scheduled time period, an updated arrival time can be determined. A determination is made for whether the selected EVCS is available for the updated time period. If the electric vehicle charging station is unavailable at the updated arrival time, a second electric vehicle charging station is selected from the plurality of electric vehicle charging stations based on, inter alia, the updated arrival time and the inputs that were received at 902-912. In particular embodiments, a time period for charging the electric vehicle corresponding to the updated arrival time is scheduled.

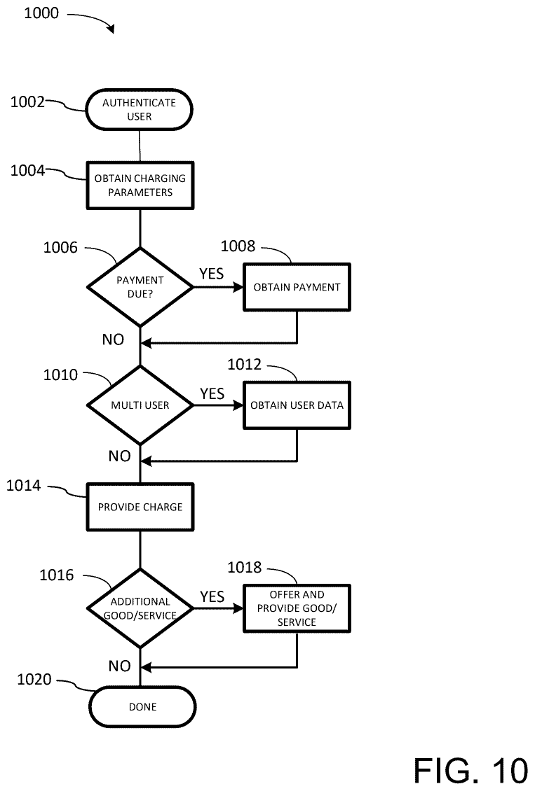

FIG. 10 is a block diagram illustrating an example of a method 1000 of operating an electric vehicle charging station. The method can be implemented by EVCS controller 406 (FIGS. 4-6) and/or computer system 1300 in FIG. 13.

At 1002, a user is authenticated. Any suitable technique can be employed. For example, if the user has an account associated with the EVCS, the user can log-in by providing a username and password (or PIN). Other techniques for authenticating include, but are not limited to providing a card to a card reader (which can read either a magnetic stripe, chip, or NFC) and optionally a password, PIN, or token assigned to the user, presenting a token, presenting a barcode, such as a QR code, or biometric data. In embodiments where a user does not have an account, the user can merely provide a credit or debit card which

At 1004, charging parameters are obtained from a customer. The parameters can include, but are not limited to, rate of charge (e.g., Level or kWh), amount of charge (e.g., time or kW) and/or plug type. In some embodiments, where time is being reserved for a scheduled charging session, an estimate time of arrival can be included. In an example embodiment, loyalty program data is included.

At 1006, a determination is made on whether payment is due. For example, a fleet account can be invoiced in the future or some loyalty programs provide a certain number of charges or charges for a predefined time period for free. If no payment is due (YES), then the method proceeds to 1010.

If at 1006, it is determined that a payment is due, the payment is collected at 1008, Any suitable method can be employed. For example, payment can be made on a mobile device that sends the payment information to the EVCS via a wireless connection like NFC, BLUETOOTH, or WIFI. In an example embodiment, payments can be made at a user interface at the EVCS, such as cash, credit and/or debit cards.

At 1010, a determination is made whether there are multiple users associated with the vehicle. For example, fleet vehicles, police cars, taxicabs, delivery vehicles, or even private vehicles can have more than one user associated with the vehicle.

If multiple users are associated with a vehicle (YES), at 1012, user data (e.g., identification) is obtained. Otherwise (NO), the method continues.

At 1014, the vehicle is charged in accordance with the user specified parameters. While the vehicle is being charged, the user can be provided with the opportunity to obtain additional services.

At 1016, if additional services are available, the user can request to use one or more of the additional services. If the user wishes to use an additional services (YES), at 1018 the service is provided to the user, otherwise (NO) charging continues until completed.

There are many types of services that can be provided that the user can employ at 1018. These services include, but are not limited to banking services, vending (POS) services, streaming/TV services, and telephone/videoconferencing services. In an example embodiment as will be described herein, payment for these services can be separate from the payment for charging the electric vehicle.

For example, for banking services the user can request a financial transaction via a user interface at the EVCS, or can initiate the transaction on a mobile device which can then send the transaction data to the EVCS or an automated banking machine coupled with the EVCS via BLUETOOTH, WIFI, or NFC.

The user is authenticated for the financial transaction which can be a separate authentication than is used for authenticating with he EVCS. Any suitable technique can be employed for authenticating the user for a banking transaction, such as bank card coupled with a PIN, token, or biometric information.

After the user is authenticated for the banking transaction, the user conducts the financial transaction responsive to authenticating the user's banking information. For example, the financial transaction can be a cash withdrawal for a requested amount of cash. Upon successfully authenticating and assuming the user has sufficient credit or funds, the user is provided the requested amount of cash. The cash can be provided by a cash dispenser coupled with the EVCS.

In an example embodiment, the user can make a deposit into an account. A cash acceptor, check acceptor, and/or cash recycler is coupled with the EVCS and can receive a deposit item. An account associated with the user is credited for an amount corresponding to the amount of the deposit item.

In an example embodiment, retail goods (or retail items) can be offered for sale by a vending machine with a POS coupled with the EVCS. In an example embodiment, the user interface of the EVCS comprises a POS system. In another example embodiment, the user can employ a mobile device (e.g., mobile device 108) to communicate with the POS system. The user selects one or more items for purchase. In an example embodiment, the user pays for the selected items via the user interface. For example, the user can insert a credit or debit card into a card reader which read a magnetic stripe or chip on the card, or alternatively, a NFC interface can be employed to read the card data. Upon payment, the user can be provided with the goods. The user interface can be employed for providing the goods to the user. For example, the goods can be retrieved and moved to an area behind a door or gate, which can be unlocked once the goods are moved there. As another example, a door where the retail item is stored can be unlocked so the user can access the item. A display on the user interface can inform the user where to find the item if it is stored in a vending area adjacent or near the EVCS (e.g., open door in Row 3, slot 7 to retrieve item).

As those skilled in the art can readily appreciate, any type of items that can be physically provided to the user can be sold. Items that can be offered for sale inluce, but are not limited to, snacks such as chips or pretzels, beverages such as soft drinks and/or hot beverages such as coffee or tea, tire repair kits and/or air, sandwiches, ice cream, fruits, and vegetables.

In an example embodiment, the user can purchase audiovisual content, such as television and/or streaming service. A request for the audio visual content is received by the EVCS. For example, the request can be received by selecting an appropriate icon or menu option on the user interface. In an example embodiment, the request can be received wirelessly from a mobile device (e.g., WIFI, BLUETOOTH, or NFC). The user can employ the user interface to pay for the purchase. For example, a credit and/or debit card reader can be employed. Alternatively, payment can be received wirelessly from a mobile device. Upon receipt of payment, the audiovisual content (e.g., streaming or Television) is provided. The content can be provided via a display and speaker on the EVCS's user interface or streamed via a wireless connection to the user's mobile device.

In an example embodiment, the user can purchase communication services, such as telecommunications and/or video conferencing. A request for the communication service is received by the EVCS. For example, the request can be received by selecting an appropriate icon or menu option on the user interface. In an example embodiment, the request can be received wirelessly from a mobile device (e.g., WIFI, BLUETOOTH, or NFC). The user can employ the user interface to pay for the purchase. For example, a credit and/or debit card reader can be employed. Alternatively, payment can be received wirelessly from a mobile device. Upon receipt of payment, the communication service (e.g., telecommunication/videoconference) is provided. The content can be provided via a display, speaker, microphone, and/or headset on the EVCS's user interface or streamed via a wireless connection to the user's mobile device. This service can be beneficial in areas where cellular service is inadequate.

At 1020, charging is completed. The EVCS discontinues providing power to the electric vehicle, and additional services (e.g., audiovisual or communications) can be terminated, making the EVCS available for the next customer. The user can unplug the electric vehicle and leave the EVCS.

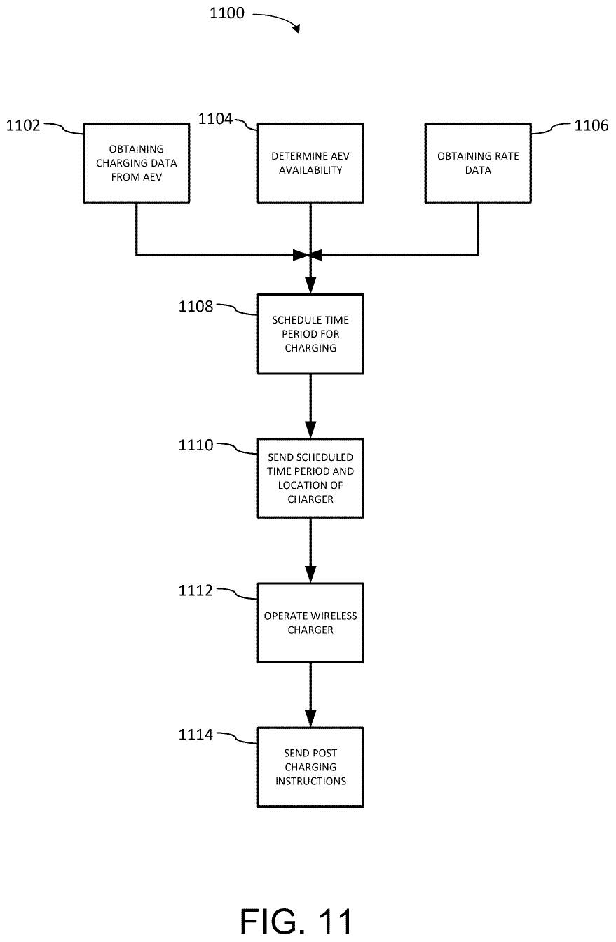

FIG. 11 is a block diagram illustrating an example of a method 1100 of charging an autonomous electric vehicle with an electric vehicle wireless (e.g., inductive) charging system. The method 1100 can be implemented on the wireless charging system 700 described in FIG. 7.

At 1102, charging data is obtained from an autonomous, electric vehicle. The charging data may include, but is not limited to data identifying the autonomous, electric vehicle (“AEV”), current battery charge level, amount of charge requested, time period vehicle is available for charging, and/or the autonomous electric vehicle's AEV current location, or where the vehicle will be parked.

At 1104, the AEV's the time when the AEV is available for charging is determined. This can be determined in any of several different ways. For example, for fleet vehicles that are parked overnight, the normal overnight time period can be determined as the time period the vehicle is available for charging. As another example, the operator of the AEV can input a time that the vehicle will be picked up. As yet another example, the controller can determine from historical data when it is likely that the vehicle will be used again (e.g., weekdays at 7 am).

At 1106, electric power rate data is obtained. In an example embodiment, the rata data is provided by the utility supplying electricity to the wireless charger that will be employed to charge the AEV. In an example embodiment, the rate data comprises a plurality of rates corresponding to a plurality of time periods. For example, the rates in the late evening may be lower than daytime or early evening rates.

At 1108, a time is scheduled for charging the AEV at a wireless charger, such as for example an in-ground wireless charger. The scheduled time period can be based in part on the charging data provided by the AEV. In an example embodiment, the scheduled time period is based in part on electricity rates. For example, AEV's can be scheduled when electricity rates are lower, and can prioritize charging times based on the lowest available rate. In another example embodiment, scheduling of the time period can be based in part on membership in a preferred customer program. For example, preferred customers can get their cars charged before other customers.

At 1110, data representative of the scheduled time period and location are provided to the AEV. In an example embodiment, the data is provided when it is time for the vehicle to move to the wireless charging station. In another embodiment, the scheduled time can be sent to the AEV and the AEV will automatically move to the wireless charger at the appropriate time to arrive during the scheduled time period. In an example embodiment, the location data comprises routing information that the AEV can employ to drive from its parked location to the wireless charger. In another example embodiment, the coordinates for the wireless charger are sent to the AEV and the AEV determines the route to the wireless charger.

At 1112, the controller operates the wireless charger to operate the wireless charger. A sensor can be employed to determine when a vehicle is present at the wireless charger. In an example embodiment, the controller is operable to communicate with the AEV to verify the correct AEV is at the charger before charging the electric vehicle. In particular embodiments, gates or other barricades can be employed to prevent unauthorized vehicles from parking at the wireless charging station.

The wireless charger is switched on and off during the scheduled time period. In another example embodiment, other operating parameters of the wireless charger, can be such as for example, amount of power, waveform, and/or frequency of wireless signal transmitted by the in-ground wireless charge ..

At 1114, which can be at the expiration of the time period, or upon completion of charging the autonomous, electric vehicle AEV, the controller provides the AEV, with post charging instructions. In an example embodiment, this cases the AEV to move away from the wireless charger. For example, the AEV can be instructed to return to its original location, e.g., parking space, or can be provided with another location.

As those skilled in the art can readily appreciate, the method 1100 can be useful for vehicle fleets where the vehicles are parked overnight in a parking facility. The AEV's can be charged overnight without requiring personnel to drive and/or connect the AEV's to electric vehicle charging stations. Alternatively, method 1100 can be useful in apartment complexes or other facilities where it would be costly to provide a sufficient number of plug-in type electric vehicle chargers.

Although the illustrated examples herein are directed to a single charging station, those skilled in the art can readily appreciate the number of controllers and in-ground wireless chargers illustrated were selected merely for ease of illustration. The example embodiments herein can be implemented on systems having any physically realizable number of controllers and/or wireless chargers.

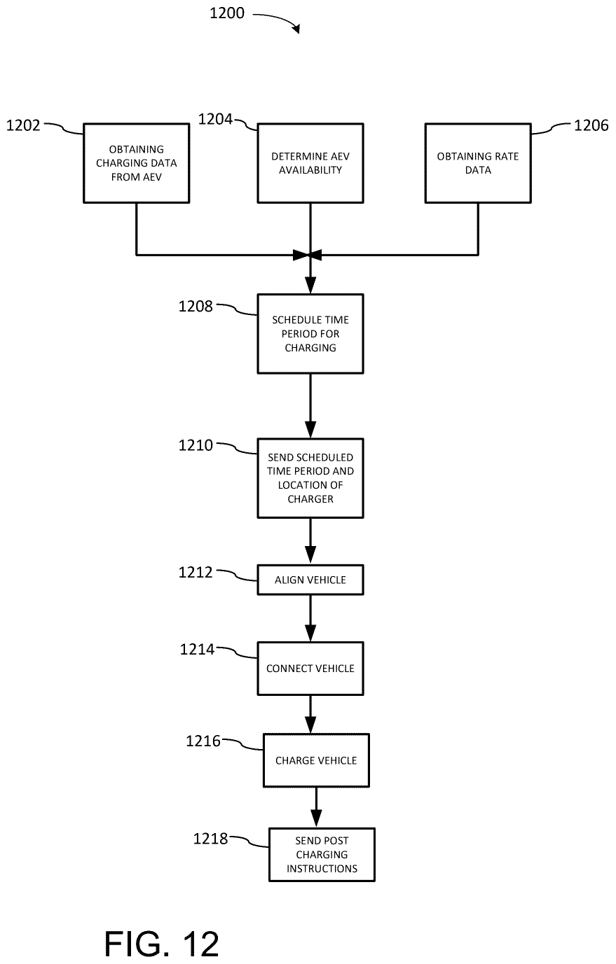

FIG. 12 is a block diagram illustrating an example of a method 1200 of charging an autonomous electric vehicle with an electric vehicle wired charging system. The method 1000 can be implemented on the wireless charging system 800 described in FIG. 8.

At 1202, charging data is obtained from an autonomous, electric vehicle. The charging data may include, but is not limited to data identifying the autonomous, electric vehicle (“AEV”), current battery charge level, amount of charge requested, time period vehicle is available for charging, and/or the autonomous electric vehicle's AEV current location, or where the vehicle will be parked. In an example embodiment, the data obtained from the electric vehicle includes type of plug and/or receptacle employed for charging the electric vehicle.

At 1204, the AEV's the time when the AEV is available for charging is determined. This can be determined in any of several different ways. For example, for fleet vehicles that are parked overnight, the normal overnight time period can be determined as the time period the vehicle is available for charging. As another example, the operator of the AEV can input a time that the vehicle will be picked up. As yet another example, the controller can determine from historical data when it is likely that the vehicle will be used again (e.g., weekdays at 7 am).

At 1206, electric power rate data is obtained. In an example embodiment, the rata data is provided by the utility supplying electricity to the wireless charger that will be employed to charge the AEV. In an example embodiment, the rate data comprises a plurality of rates corresponding to a plurality of time periods. For example, the rates in the late evening may be lower than daytime or early evening rates.

At 1208, a time is scheduled for charging the AEV at the EVCS. The scheduled time period can be based in part on the charging data provided by the AEV. In an example embodiment, the scheduled time period is based in part on electricity rates. For example, AEV's can be scheduled when electricity rates are lower, and can prioritize charging times based on the lowest available rate. In another example embodiment, scheduling of the time period can be based in part on membership in a preferred customer program. For example, preferred customers can get their cars charged before other customers.

At 1210, data representative of the scheduled time period and location are provided to the AEV. In an example embodiment, the data is provided when it is time for the vehicle to move to the wireless charging station. In another embodiment, the scheduled time can be sent to the AEV and the AEV will automatically move to the wireless charger at the appropriate time to arrive during the scheduled time period. In an example embodiment, the location data comprises routing information that the AEV can employ to drive from its parked location to the wireless charger. In another example embodiment, the coordinates for the wireless charger are sent to the AEV and the AEV determines the route to the wireless charger.

At 1212, the AEV is aligned with the EVCS. For example, the plug and/or receptacle of the AEV can be aligned with the receptacle of the and/or plug of the EVCS. In an example embodiment, the EVCS sends instructions to the AEV to move the AEV into alignment. In another example embodiment, the AEV can be parked on a movable structure, such as for example, a pallet or a pad, and the controller can cause the movable structure to move the AEV into alignment with the EVCS.

At 1214, the AEV is connected to the EVCS. In an example embodiment, a plug at the end of a connector on the is moved and inserted into a receptacle. In another example embodiment, a receptacle at the end of a connector on the EVCS is moved and coupled with a plug on the AEV. Alternatively, a plug or receptacle can be moved from the AEV for coupling with the EVCS.

At 1216, the controller operates the EVCS to provide power via the cable connecting the EVCS to the EV to charge the AEV. A sensor can be employed to determine when a vehicle is present at the wireless charger. In an example embodiment, the controller is operable to communicate with the AEV to verify the correct AEV is at the charger before charging the electric vehicle. In particular embodiments, gates or other barricades can be employed to prevent unauthorized vehicles from parking at the EVCS.

The EVCS is switched on when an AEV is present and off when no AEV is present. In another example embodiment, other operating parameters of the wireless charger, such as for example, amount of power, waveform, and/or frequency of wireless signal transmitted by the in-ground wireless charge can be varied.

At 1218, which can be at the expiration of the time period, or upon completion of charging the autonomous electric vehicle AEV, the controller provides the AEV, with post charging instructions. In an example embodiment, this cases the AEV to move away from the EVCS. For example, the AEV can be instructed to return to its original location, e.g., parking space, or can be provided with another location.

As those skilled in the art can readily appreciate, the method 1200 can be useful for vehicle fleets where the vehicles are parked overnight in a parking facility. The AEV's can be charged overnight without requiring personnel to drive and/or connect the AEV's to electric vehicle charging stations. Alternatively, method 1200 can be useful in apartment complexes or other facilities where it would be costly to provide a sufficient number of plug-in type electric vehicle chargers.

Although the illustrated examples herein are directed to a single charging station, those skilled in the art can readily appreciate the number of controllers and in-ground wireless chargers illustrated were selected merely for ease of illustration. The example embodiments herein can be implemented on systems having any physically realizable number of controllers and/or wireless chargers.

FIG. 13 is a block diagram that illustrates a computer system 1300 upon which an example embodiment may be implemented. The computer system 1300 can be employed to implement the mobile device logic 202 (FIG. 2), server logic 302 (FIG. 3), EVCS controller 406 (FIGS. 4-6), controller logic 608 (FIG. 6), controller 704 (FIG. 7), controller 804 (FIG. 8), method 900 (FIG. 9), method 1000 (FIG. 10), method 1100 (FIG. 11), and/or method 1200 (FIG. 12).

Computer system 1300 includes a bus 1302 or other communication mechanism for communicating information and a processor 1304 coupled with bus 1302 for processing information. Computer system 1300 also includes a main memory 1306, such as random access memory (RAM) or other dynamic storage device coupled to bus 1302 for storing information and instructions to be executed by processor 1304. Main memory 1306 also may be used for storing a temporary variable or other intermediate information during execution of instructions to be executed by processor 1304. Computer system 1300 further includes a read only memory (ROM) 1308 or other static storage device coupled to bus 1302 for storing static information and instructions for processor 1304. A storage device 1310, such as a magnetic disk or optical disk, is provided and coupled to bus 1302 for storing information and instructions.

Computer system 1300 may be coupled via bus 1302 to a display 1312 such as a cathode ray tube (CRT) or liquid crystal display (LCD), for displaying information to a computer user. An input device 1314, such as a keyboard including alphanumeric and other keys is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312. This input device typically has two degrees of freedom in two axes, a first axis (e.g. x) and a second axis (e.g. y) that allows the device to specify positions in a plane. In an example embodiment, the input device 1314 is a touch screen.

An aspect of an example embodiment is related to the use of computer system 1300 for electric vehicle charging. According to one embodiment, electric vehicle charging is provided by computer system 1300 in response to processor 1304 executing one or more sequences of one or more instructions contained in main memory 1306. Such instructions may be read into main memory 1306 from another computer-readable medium, such as storage device 1310. Execution of the sequence of instructions contained in main memory 1306 causes processor 1304 to perform the process steps described herein. One or more processors in a multi-processing arrangement may also be employed to execute the sequences of instructions contained in main memory 1306. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 1304 for execution. Such a medium may take many forms, including but not limited to non-volatile media. Non-volatile media include for example optical or magnetic disks, such as storage device 1310. Common forms of computer-readable media include for example RAM, PROM, EPROM, FLASHPROM, CD, DVD, SSD or any other memory chip or cartridge, or other medium from which a computer can read.

Computer system 1300 also includes a communication interface 1318 coupled to bus 1302. Communication interface 1318 provides a two-way data communication coupling to a network link 1320 that is connected to a local network 1322. For example, communication interface 1318 may be an integrated services digital network (ISDN) card or a modem to provide a data communication connection to a corresponding type of telephone line. As another example, communication interface 1318 may be a local area network (LAN) card to provide a data communication connection to a compatible LAN. Wireless links may also be implemented. In any such implementation, communication interface 1318 sends and receives electrical, electromagnetic, or optical signals that carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communications through the worldwide packet data communication network, now commonly referred to as the “Internet” 1328. Local networks 1322 and Internet 1328 both use electrical, electromagnetic, or optical signals that carry the digital data to and from computer system 1300, are exemplary forms of carrier waves transporting the information.

Described above are example embodiments. It is, of course, not possible to describe every conceivable combination of components or methodologies for purposes of describing the example embodiments, but one of ordinary skill in the art will recognize that many further combinations and permutations of the example embodiments are possible. Accordingly, it is intended to embrace all such alterations, modifications and variations that fall within the spirit and scope of any claims filed in applications claiming priority hereto interpreted in accordance with the breadth to which they are fairly, legally and equitably entitled.

1. A method, comprising:
providing electric power from an electric vehicle charging station to an electric vehicle;
receiving, via a user interface associated with the electric vehicle charging station, a request to conduct a financial transaction;
authenticating a user's banking information;
conducting the financial transaction responsive to authenticating the user's banking information;
offering a plurality of retail items for sale at the electric vehicle charging station;
receiving, via the user interface, a request to purchase a selected one of the plurality of retail items;
receiving, via the user interface, payment for the selected one of the plurality of retail items;
providing the selected one of the plurality of retail items to the user in response to receiving payment for the selected one of the plurality of retail items;
obtaining charging data from an autonomous, electric vehicle;
scheduling, based in part on the charging data, a time period for charging the electric vehicle; and
sending data representative of a scheduled time period and a location of a wireless charger that causes the autonomous, electric vehicle to arrive at the electric vehicle charging station for charging during the scheduled time period.

2. The method of claim 1, further comprising
authenticating a user charging the electric vehicle at the user interface of an electric vehicle charging station; and
electric power from the electric vehicle charging station is provided to the electric vehicle responsive to authenticating the user.

3. The method of claim 1, wherein the financial transaction is a cash withdrawal for a requested amount of cash from a financial account, the method further comprising providing the requested amount of cash and debiting the financial account.

4. The method of claim 3, further comprising:
obtaining user identification data selected from a group consisting of facial recognition data, biometric data, and a combination of facial recognition data and biometric data;
authenticating the user at an automated banking machine that is remote from the electric vehicle charging station, the authenticating comprises one of a group consisting of employing facial recognition technology at the automated banking machine with the obtained facial recognition data, comparing biometric data received from the user at the automated banking machine with the obtained biometric data, and a combination of employing facial recognition technology at the automated banking machine with the obtained facial recognition data and comparing biometric data received from the user at the automated banking machine with the obtained biometric data; and
wherein providing the requested amount of cash and debiting the financial account is performed responsive the authenticating the user at the automated banking machine.

5. The method of claim 1, wherein the financial transaction is a deposit into an account, the method further comprising:
receiving a deposit item; and
crediting an account associated with the user for an amount corresponding to the deposit item.

6. The method of claim 1, wherein the selected one of the plurality of retail items is provided via the user interface, to the user in response to receiving payment for the selected one of the plurality of retail items.

7. The method of claim 1, further comprising:
obtaining user identification data selected from a group consisting of facial recognition data, biometric data, and a combination of facial recognition data and biometric data;
authenticating the user by a point of sale device that is remote from the electric vehicle charging station, the authenticating comprises one of a group consisting of employing facial recognition technology at an automated banking machine with the obtained facial recognition data, comparing biometric data received from the user at the point of sale device with the obtained biometric data, and a combination of employing facial recognition technology at the point of sale device with the obtained facial recognition data and comparing biometric data received from the user at the point of sale device with the obtained biometric data; and
wherein upon authentication, the user is permitted to bypass the remote point of sale device to receive the selected one of the plurality of retail items.

8. The method of claim 1, further comprising:
receiving, via the user interface, a request to purchase audio visual content;
receiving, via the user interface, payment for the audio visual content; and
providing the audio visual content responsive to receiving payment for the audio visual content.

9. The method of claim 1, further comprising:
receiving via the user interface, a request for to purchase a telecommunications connection;
receiving, via the user interface, payment for the telecommunication connection; and
providing the telecommunications connections in response to receiving payment for the telecommunications connection.

10. The method of claim 1, further comprising:
receiving via the user interface, a request to establish a videoconference;
receiving, via the user interface, payment for the videoconference; and
providing the videoconference in response to receiving payment for the videoconference.

11. The method, of claim 1, wherein the electric vehicle charging station comprises a wireless charger that provides charging to the autonomous electric vehicle wirelessly.

12. The method of claim 11, wherein the wireless charger is an in-ground wireless charger.

13. The method of claim 1, further comprising
selecting a plug by the electric vehicle charging station that is compatible with the autonomous electric vehicle;
aligning the autonomous electric vehicle with the plug; and
coupling the plug with a receptable on the autonomous electric vehicle to provide charging to the autonomous electric vehicle.

14. The method of claim 1, further comprising
selecting a receptable by the electric vehicle charging station that is compatible with the autonomous electric vehicle;
aligning the autonomous electric vehicle with the receptacle; and
coupling the receptacle to a plug on the autonomous electric vehicle to providing charging to the autonomous electric vehicle.

15. The method of claim 1, the scheduling further comprising:
obtaining data representative of electricity rates for a plurality of time periods; and
selecting the scheduling time period from the plurality of time periods based on a lowest electricity rate.

16. The method of claim 1, further comprising providing route guidance to the electric vehicle charging station to the autonomous, electric vehicle.

17. The method of claim 1, further comprising:
verifying the autonomous, electric vehicle is at the wireless charging station during the scheduled time period; and
operating the electric vehicle electric station to charge the autonomous, electric vehicle.

18. The method of clam 1, further comprising:
obtaining charging data from a plurality of autonomous, electric vehicles;
determining an amount of charge for the plurality of autonomous electric vehicles that is less than a full charge based on the charging data;
determine an amount of time for charging the autonomous, electric vehicles corresponding to the determined amount of charge the plurality of autonomous, electric vehicles'
scheduling, based in part on the charging data, time periods for charging the plurality of autonomous, electric vehicle with a wireless charger; and
sending data representative of a scheduled time and a location of the wireless charger to the autonomous electric vehicles that causes the plurality of autonomous, electric vehicle to arrive at the wireless charger for charging during their scheduled time period.

19. The method of claim 1, further comprising:
obtaining a plurality of time periods that a wireless charging station is available;
scheduling a selected time period selected from the plurality of time periods;
communicating the selected time period to the wireless charging station; and
operating an autonomous electric vehicle to move to the wireless charger for charging during the scheduled time period.

20. The method of claim 19, wherein the wireless charger is an inductive charger.
